(19) United States
(12) Patent Application Publication
(10) Pub. No.: US 2013/0036622 A1
(43) Pub. Date: Feb. 14, 2013

(54) DEVICE AND METHOD FOR THERMALLY PRE-TREATING SOLID RAW MATERIALS IN A CONCENTRICALLY STEPPED FLUIDIZED BED

(71) Applicants: Ralf Abraham, Bergkamen (DE); Stefan Hamel, Wenden (DE)

(72) Inventors: Ralf Abraham, Bergkamen (DE); Stefan Hamel, Wenden (DE)

(73) Assignee: THYSSENKRUPP UHDE GMBH, Dortmund (DE)

(21) Appl. No.: 13/640,761

(22) PCT Filed: Mar. 31, 2011
(86) PCT No.: PCT/EP2011/001627

§ 371 Date: Oct. 12, 2012

(30) Foreign Application Priority Data
Apr. 23, 2010 (DE) 10 2010 018 219.2

(51) Int. Cl. B01J 8/26; F26B 7/00

(52) U.S. Cl. 34/368; 422/141

(57) ABSTRACT

A fluidized bed reactor for thermally pre-treating solid raw materials containing water using a stepped, stationary fluidized bed, including at least two concentrically arranged treatment zones. Each treatment zone has at least one separate gas inlet for fluidizing gas. Each treatment zone is divided from the respective other adjacent treatment zone by an overflow weir, and the innermost treatment zone has an outlet on the floor for reaction products. The solid raw material is fed into the outermost treatment zone of the fluidized bed. A first temperature and a first residence time are set in a first step, and a second temperature and a second residence time are set in a second. The temperatures of the fluidizing gas of the first and second steps are controlled separately. The fluidized material flows from the outer treatment zone over a weir into the inner treatment zone, and is drawn through the outlet.

The invention relates to the thermal pre-treatment of solid energy feedstocks including, for example, biogenic and other highly reactive fuels, fossil fuels and residuals, in a staged fluidised bed. The staged arrangement consists of two concentrically arranged treatment zones, each of which can be adjusted individually with regard to residence time and temperature.

Pre-treatment means drying or torrefaction of the feedstock. Torrefaction, also known as “mild pyrolysis”, means decomposition reactions of organic feedstocks such as biomass below approx. 300° C. Above 400° C. only a small portion of solid material is left in the form of coke, approx. 20 wt.% beech wood at 400° C., whereas at about 250° C. approx. 80 to 95 wt.%—depending on the type of biomass—is left in the form of solid material. The treatment of biomass at 220° C. to 350° C. has the effect that the tenacity resulting from the fibre structure decreases. This makes subsequent additional comminution easier and reduces the energy demand required for the comminution to a considerable degree.

A typical characteristic of a single-stage fluidised bed is the residence time distribution of the withdrawn product particles. This is of disadvantage especially in the case of the torrefaction which is aimed at, as it will result in an undesired variation of the elementary composition of the product on account of the different residence times.

The aim of the invention therefore is to allow that the residence time distribution of the treated particles be adjusted more homogeneously in order to equalise the particle residence times. These aims are pursued by arranging the fluidised bed in stages and performing a thermal treatment in different treatment zones and determining their geometric configuration.

The aim of the invention is achieved by using a fluidised-bed reactor for thermal pre-treatment of solid feedstocks containing water, comprising
devices for holding a staged, stationary fluidised bed of at least two concentrically arranged treatment zones, with
each of the treatment zones having at least one separate gas inlet for fluidising gas, and
the individual treatment zones being connected by overflows only,
each treatment zone being separated from the adjacent treatment zone by an overflow weir,
the outermost treatment zone being equipped with a feed device for feedstock, and
the innermost treatment zone being equipped with a discharge for pre-treated feedstocks.

An embodiment of the invention provides for an overflow weir which is lowered in part and offset by 180 degrees relative to the feed device. If the configuration involves several concentrically arranged treatment zones, several overflow weirs can be provided, which are all lowered in part and offset by 180 degrees relative to the overflow of the respective outer treatment zone.

Another embodiment of the invention provides for an underflow weir in at least one of the treatment zones.

A further embodiment of the invention provides for separate gas outlet devices in each treatment zone. Nozzles, openings, slots or bells are provided as gas inlet devices for fluidising gas.

The aim of the invention is achieved by a method for the thermal pre-treatment of solid feedstocks in a fluidised bed operated in stages in a fluidised-bed reactor with at least two concentrically arranged treatment zones, with
the solid feedstock being fed to the outermost treatment zone of the fluidised bed, with the fluidised bed being stirred and fluidised by means of fluidising gas,
a specific temperature and a specific residence time being adjusted for each stage of the fluidised bed,
the temperatures of the fluidising gas being controlled separately for the respective stages,
the material to be fluidised in the fluidised bed flowing from the respective outer treatment zone via the overflow weir into the respective inner treatment zone, and
the material to be fluidised in the fluidised bed being discharged with the product from the bottom of the innermost treatment zone.

The invention is explained in more detail by means of six figures.

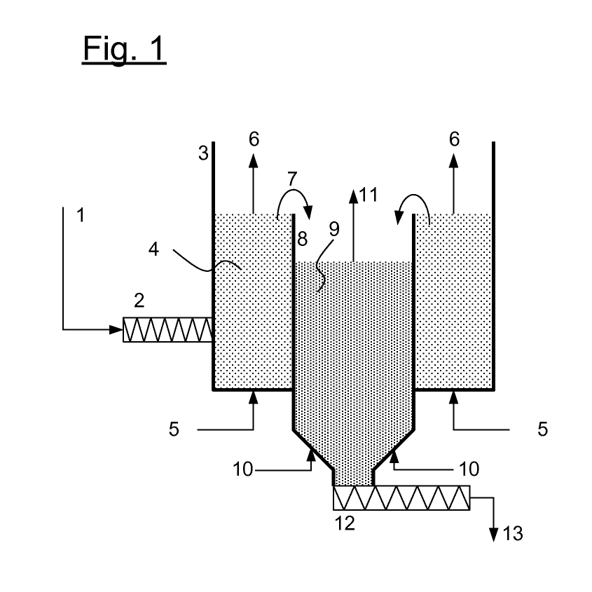

FIG. 1 shows the example of a variant with two treatment zones,

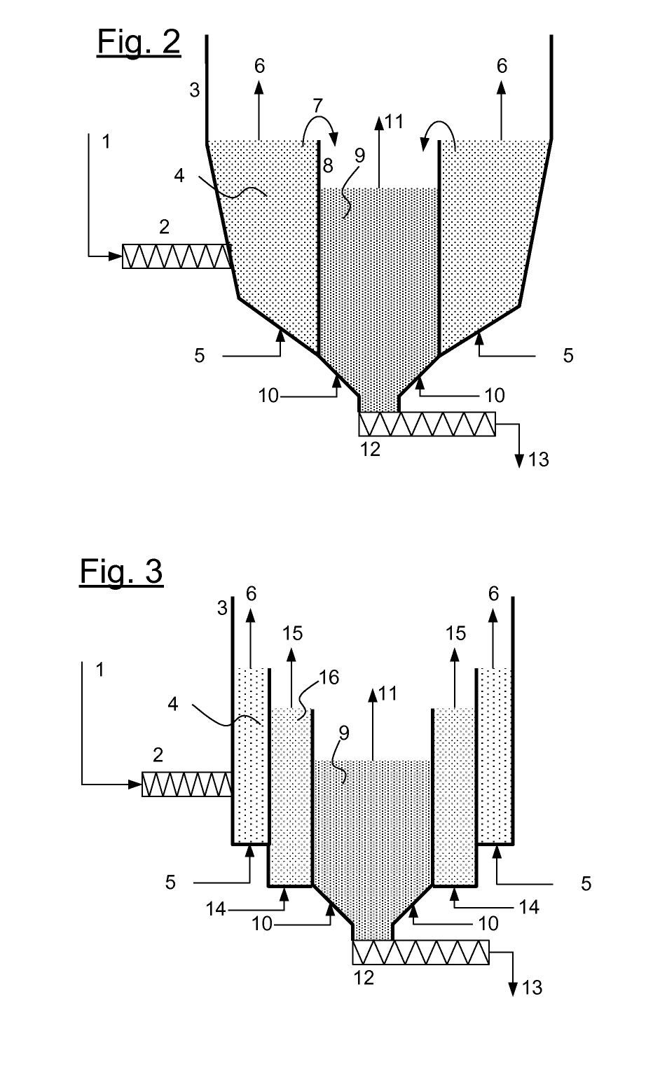

FIG. 2 shows—analogously to FIG. 1—a two-stage contrivance,

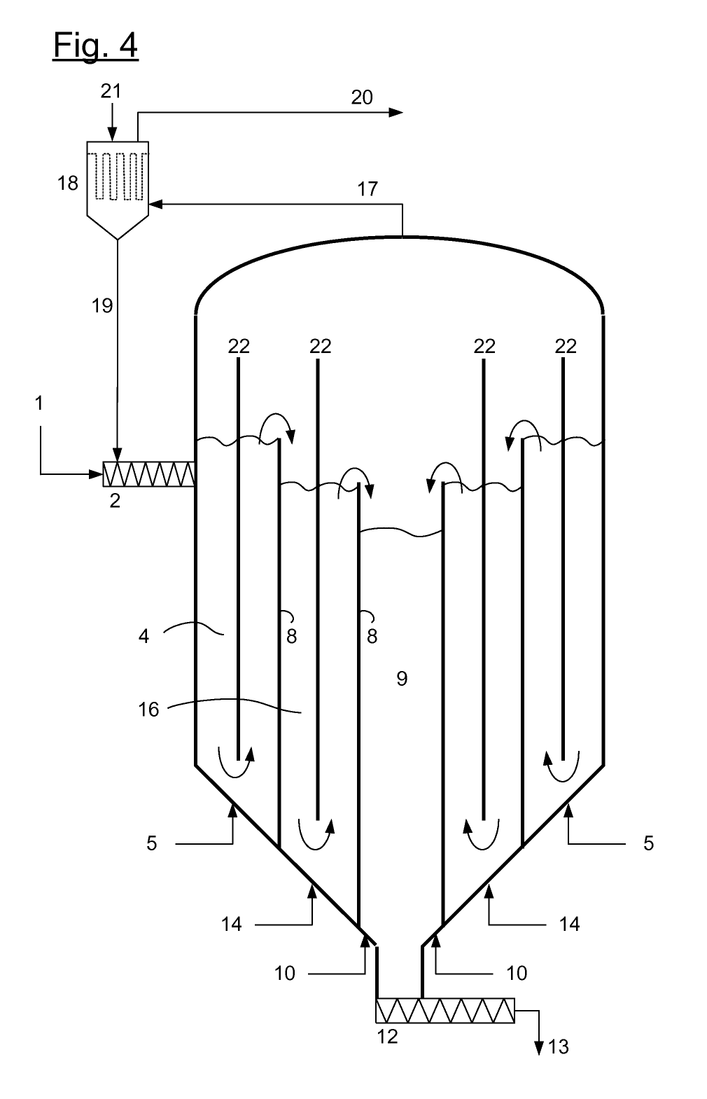

Each of FIGS. 3 and 4 shows a contrivance according to the invention with three concentric treatment zones,

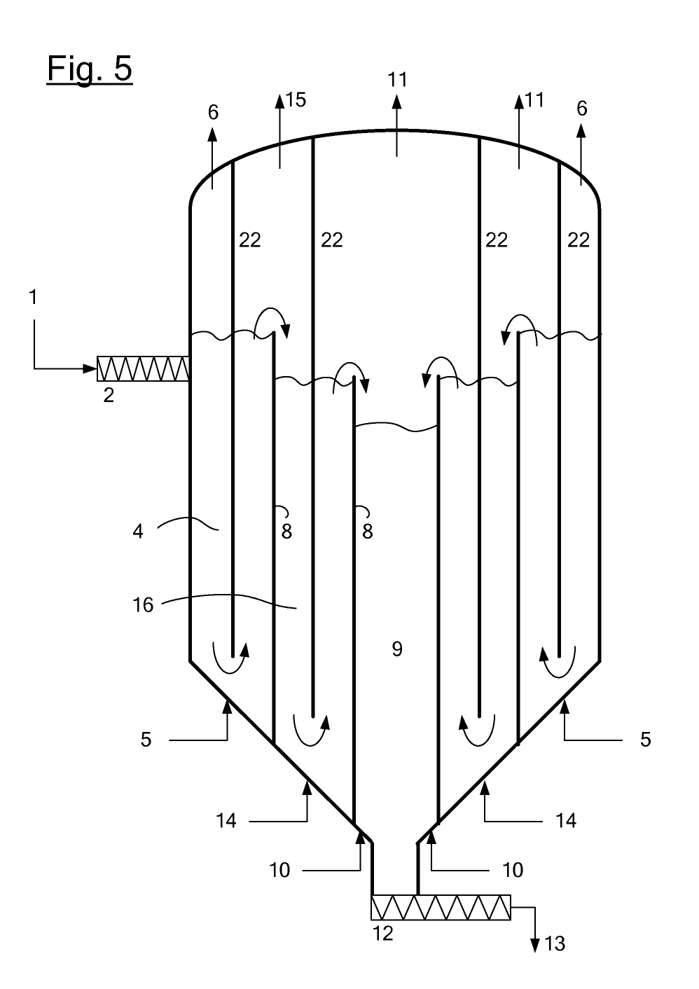

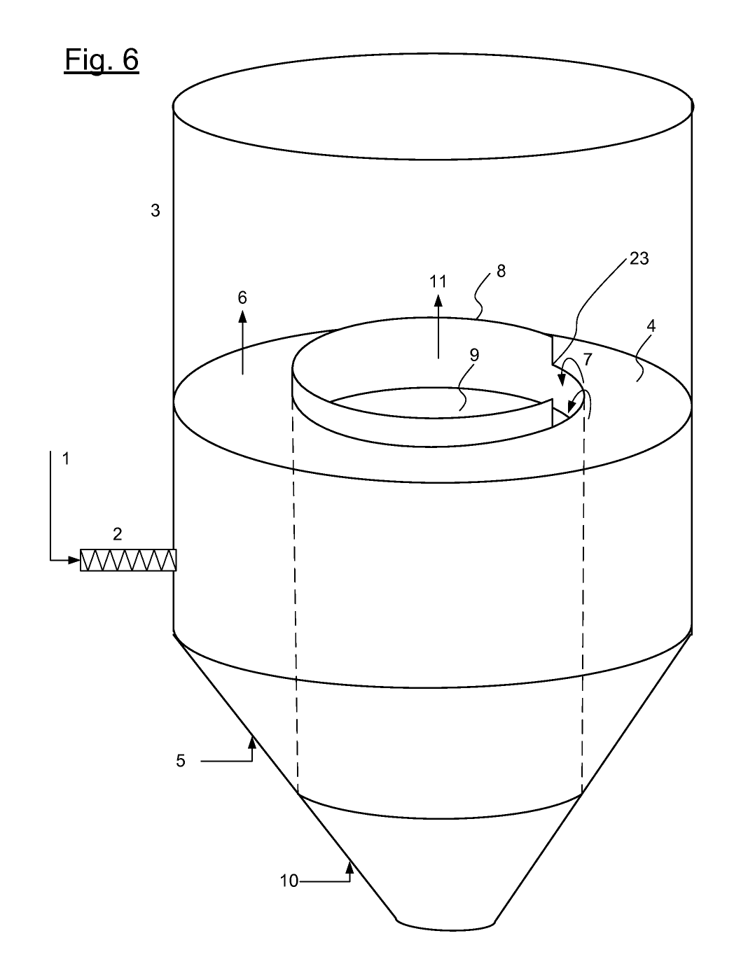

FIGS. 5 and 6 show further advantageous embodiments of the invention.

FIG. 1 shows the example of a variant with two treatment zones. Feedstock 1 is fed to first treatment zone 4 of reactor 3 via feeding screw 2. Treatment zone 4 is stirred and fluidised by means of fluidising gas 5. The temperature of fluidising gas 5, for example, is selected such that the feedstock undergoes drying in first treatment zone 4. Waste gas 6 from fluidising gas and vaporised water leaves treatment zone 4. Fluidisation and uninterrupted feedstock supply allow continuous conveying of dried feedstock 1 into second treatment zone 9 via overflow 7. The two treatment zones are separated by partition wall 8, the arrangement is concentric. Treatment zone 9 is fluidised by means of fluidising gas 10. The temperature of fluidising gas 10 can be set as required by the requested treatment. If torrefaction of feedstock 1 is to be performed, the temperature of fluidising gas 10 is selected such that a mean temperature of, for example, 250° C. is established in the fluidised bed of treatment zone 9. Waste gas 11 from fluidising gas 10 and the gaseous components released during torrefaction leaves treatment zone 9. Treated product 13 is discharged at the bottom of treatment zone 9 via a discharge screw 12.

FIG. 2 shows—analogously to FIG. 1—a two-stage contrivance. In contrast to FIG. 1, the bottom of treatment zone 4 is conical just as the wall of reactor 3.

FIG. 3 shows a contrivance according to the invention with three concentric treatment zones 4, 16, and 9, each of which undergoes separate fluidisation. FIG. 4 shows a contrivance according to the invention with three concentric treatment zones 4, 16, and 9, each being provided with a separate fluidising gas inlet. Treatment zones 4 and 16 themselves are zoned by means of an underflow weir 22. The fluidised solid must pass underflow weir 22 first before it reaches next treatment zone 9 or 16 via partition wall 8 which is designed as an overflow weir. All waste gas 17, consisting of the fluidising gases,—depending on the operating mode—of the released water vapour from the drying section and the released volatiles, leaves the reactor laden with dust typical of a fluidised bed. Waste gas 17 then passes dust separator 18, before it is further used or treated or emitted into the atmosphere. In FIG. 4, dust separator 18 is represented by way of example as a filter with the required back-flushing gas 21, but may also be provided, for instance, as a cyclone, electrostatic precipitator or other type of dust separator according to the state of the art. Dust 19 which has been separated from the gas is advantageously recycled, as shown, and re-fed to the reactor together with the feedstock. Not represented is a further advantageous variant, i.e. to supply dust 19 directly to product stream 13.

FIG. 5 shows another advantageous embodiment of the invention. Based on the representation according to FIG. 4, the partition walls which constitute underflow weirs 22 in the treatment zones extend to as far as the reactor head in FIG. 5. This raises the possibility of providing separate waste gas stream outlets 6, 11, and 15. These streams may, for example, be led to an individual subsequent treatment or disposal. Thus it is possible, for instance, to provide for an individual dust removal. It is also possible to use one or several of the part-streams to supply fluidising gas 10 to another treatment zone. It would be of advantage, for example, to re-circulate waste gas 11 withdrawn from central treatment zone 9 and to supply fluidising gas 5 or 14 at least in part. This would require re-heating depending on the temperature level, dust removal in the case of need and an increase in pressure.

FIG. 6 shows a further advantageous embodiment of the invention. Based on the representation in FIG. 1 or 2, FIG. 6 shows an optimised configuration of overflow weir 8. Overflow weir 8 has a recess 23 which constitutes overflow 7. The particles fluidised in treatment zone 4 will preferably flow over to the next treatment zone 9 at this lowest point of overflow weir 8. A special advantage will evolve if this recess 23 is arranged vis-à-vis feeding screw 2, which will considerably prolong the residence time of the particles and significantly homogenise the residence time distribution.

Applicable to the exemplary embodiments and to other possible—but not shown—embodiments in accordance with the invention is that the dimensions of the treatment zones can be selected individually as required by the residence time planned for the respective treatment zone.

Feeding screw 2 supplies treatment zone 4 from the outside, the aim being to achieve a maximum residence time of the particles. This means that there are two configurations:
1) The solids transport from treatment zone 4 to the next treatment zone is implemented via an overflow as shown in FIGS. 1, 2, and 3, in such case the feeding screw is to be positioned in the lower bed range.
2) The solids transport from treatment zone 4 is implemented first via an underflow as shown in FIG. 4, in such case the feeding screw is to be positioned in the upper bed range.
   Also conceivable—depending on mass flows—are several feeding screws distributed across the circumference.

Each treatment zone is supplied with individually temperature-controlled fluidising gas.
Owing to the concentric configuration, i.e. the roundness of reactor 3 and partition wall 8, fluidising gas 5 and 10 can be fed such that a spin is produced in the fluidised bed of the treatment zone and in each treatment zone.
The external wall of reactor 3 can be designed with double walls and supplied with additional heating medium.
Partition wall 8 can be of heat-conducting design so that heat is additionally exchanged between the treatment zones. If treatment zone 4 undergoes drying and treatment zone 9 torrefaction, heat is transported from the inside to the outside.

The bottom of the inner treatment zone can be conical and discharge screw 12 designed as cooling screw.

Usable as fluidising gases are
inert gas such as nitrogen or carbon dioxide or mixtures thereof,
air or “depleted” air, which is air plus addition of nitrogen, for example, to reduce the oxygen content,
flue gases; to heat gas to be supplied, it is common practice to burn a fuel in an auxiliary firing system. The hot flue gas produced is mixed with air and/or nitrogen to the requested temperature and then used as fluidising gas.
recycle gas; if, for example, part of dedusted waste gas 20 is recycled, it can be mixed with fresh gas, i.e. flue gas, inert gas or air and re-heated and then supplied to the contrivance as fluidising gas.

The gas distribution plate can be designed such that each treatment zone is provided with its own gas distributor. For this, two variants can be recommended:
Nozzle tray, variant 1, advantageous: FIG. 1 shows treatment zone 4 with a flat gas distribution plate. In this case, an “open” nozzle tray as commonly used in fluidised beds could be recommended, through which solids can be discharged downwards, for example, in the case of impurities or if the reactor is to be emptied for a down-time. An “open” nozzle tray is also advisable if the bottom is generally conical as shown in FIGS. 2 to 5.
Nozzle tray, variant 2: Here, a generally conical bottom is represented for all gas distributors. To allow emptying of the reactor, wall 8 may be provided with flaps so that the whole amount of solids can get into inner treatment zone 9 and be discharged through a central discharge.

### LIST OF REFERENCE NUMBERS AND DESIGNATIONS

1 Feedstock
2 Feeding screw
3 Reactor
4 Treatment zone
5 Fluidising gas
6 Waste gas
7 Overflow
8 Partition wall/overflow weir
9 Treatment zone
10 Fluidising gas
11 Waste gas
12 Discharge screw
13 Product
14 Fluidising gas
15 Waste gas
16 Treatment zone
17 Waste gas
18 Dust separator
19 Dust
20 Dedusted waste gas
21 Back-flushing gas
22 Underflow weir
23 Recess

1. A fluidised-bed reactor for the thermal pre-treatment of solid feedstocks containing water, wherein it is provided with devices for holding a staged, stationary fluidised bed of at least two concentrically arranged treatment zones, with
each of the treatment zones having at least one separate gas inlet for fluidising gas, and
the individual treatment zones being connected by overflows only,
each treatment zone being separated from the adjacent treatment zone by an overflow weir,
the outermost treatment zone being equipped with a feed device for feedstock, and
the innermost treatment zone being equipped with a discharge for pre-treated feedstocks.

2. The fluidised-bed reactor according to claim 1, wherein it is provided with an overflow weir, which is lowered in part and offset by 180 degrees relative to the feed device.

3. The fluidised-bed reactor according to claim 2, wherein it is provided with overflow weirs, which are all lowered in part and offset by 180 degrees relative to the overflow of the respective outer treatment zone.

4. The fluidised-bed reactor according to claim 1, wherein it is provided with an underflow weir in at least one of the treatment zones.

5. The fluidised-bed reactor according to claim 1, wherein each treatment zone is provided with separate gas outlet devices.

6. The fluidised-bed reactor according to claim 1, wherein that the gas inlet for fluidising gas is provided with nozzles, openings, slots or bells.

7. A method for the thermal pre-treatment of solid feedstocks in a fluidised bed operated in stages in a fluidised-bed reactor with at least two concentrically arranged treatment zones, wherein
the solid feedstock is fed to the outermost treatment zone of the fluidised bed, with the fluidised bed being stirred and fluidised by means of fluidising gas,
a specific temperature and a specific residence time are adjusted for each stage of the fluidised bed,
the temperatures of the fluidising gas are controlled separately for the respective stages,
the material to be fluidised in the fluidised bed flowing from the respective outer treatment zone via the overflow weir into the respective inner treatment zone, and
the material to be fluidised in the fluidised bed being discharged with the product from the bottom of the innermost treatment zone.
